(19) United States
(12) Patent Application Publication
(10) Pub. No.: US 2010/0191534 A1
(43) Pub. Date: Jul. 29, 2010

(54) METHOD AND APPARATUS FOR COMPRESSION OR DECOMPRESSION OF DIGITAL SIGNALS

(75) Inventors: Sang-Uk Ryu, San Diego, CA (US); Yuriy Reznik, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/690,458

(22) Filed: Jan. 20, 2010

Related U.S. Application Data
(60) Provisional application No. 61/147,033, filed on Jan. 23, 2009.
(60) Provisional application No. 61/170,976, filed on Apr. 20, 2009.

(51) Int. Cl. G10L 13/00

(52) U.S. Cl. 704/262

(57) ABSTRACT

The subject matter disclosed herein relates generally to a system and method for linear prediction of sample values.

### CROSS-REFERENCES TO RELATED APPLICATIONS

This application claims priority to provisional patent application Ser. Nos. 61/147,033, entitled “Compressed-Domain Predictive Coding for Lossless Compression of G.711 PCM Speech,” which was filed on Jan. 23, 2009; and 61/170,976, entitled “Encoding of Prediction Residual in G.711 LLC Codec,” which was filed on Apr. 20, 2009, each of which are assigned to assignee of currently claimed subject matter.

### BACKGROUND

1. Field

The subject matter disclosed herein relates to encoding or decoding digital content.

2. Information

Data compression refers to a process that allows exact original signals to be reconstructed from compressed signals. Audio compression comprises a form of compression designed to reduce a transmission bandwidth requirement of digital audio streams or a storage size of audio files. Audio compression processes may be implemented in a variety of ways including computer software as audio codecs.

Lossless audio compression produces a representation of digital signals that may be expanded to an exact digital duplicate of an original audio stream. For various forms of digitized content, including digitized audio signals, for example, lossless compression or decompression may be desirable in a variety of circumstances.

### BRIEF DESCRIPTION OF THE FIGURES

Non-limiting and non-exhaustive features will be described with reference to the following figures, wherein like reference numerals refer to like parts throughout the various figures.

FIG. 1 illustrates a compression and transmission system according to one or more implementations;

FIG. 2 illustrates a compression and transmission system for compressed audio/speech signal sample values utilizing a nonlinear compander that performs compressed domain predictive coding according to one or more implementations;

FIG. 3 illustrates a predictor according to one or more implementations;

FIG. 4 illustrates an encoder side of a compression system utilizing a linear predictor according to one or more implementations;

FIG. 5 illustrates a decoder side of a compression system utilizing a linear predictor according to an implementation;

FIG. 6 illustrates a chart of a set of reconstruction points for different index signal values according to one or more implementations

FIG. 7 illustrates a process for determining companded domain residual signal sample values according to one or more implementations;

FIG. 8 illustrates a functional flow of operations within a linear predictor according to one or more implementations;

FIG. 9 illustrates a system for implementing a compression scheme that incorporates order selection into a linear prediction analysis structure according to one or more implementations;

FIG. 10 illustrates a functional block diagram of a linear prediction process according to one or more implementations;

FIG. 11 illustrates a system for residual signal conversation according to one or more implementations;

FIG. 12 illustrates a process for determining an order of a linear predictor according to one or more implementations;

FIG. 13 is a functional block diagram of a process for coding according to one or more implementations;

FIG. 14 illustrates a functional block diagram of a system for performing relatively high order linear prediction according to one or more implementations;

FIG. 15 illustrates a functional block diagram of a system for performing relatively low order linear prediction according to one or more implementations;

FIG. 16 illustrates a functional block diagram of a process for computing bit rates for determining linear prediction coefficients according to one or more implementations; and

FIG. 17 illustrates an encoder according to one or more implementations.

### SUMMARY

In one particular implementation, a method or apparatus may be provided. An apparatus may comprise a linear predictor to generate one or more residual signal sample values corresponding to input signal sample values based at least in part on linear predication coding using linear prediction coefficients. One or more companders may generate companded domain signal sample values based at least in part on input signal sample values. A linear predictor and one or more companders may be arranged in a configuration to generate companded domain residual signal sample values. It should be understood, however, these are merely example implementations and that claimed subject matter is not limited in this respect.

### DETAILED DESCRIPTION

Reference throughout this specification to “one example”, “one feature”, “an example” or “one feature” means that a particular feature, structure, or characteristic described in connection with the feature or example is included in at least one feature or example of claimed subject matter. Thus, appearances of the phrase “in one example”, “an example”, “in one feature” or “a feature” in various places throughout the specification are not necessarily all referring to the same feature or example. Furthermore, the particular features, structures, or characteristics may be combined in one or more examples or features.

The terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense.

Some portions of the detailed description included herein may be presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Signals, such as audio signals, may be transmitted from a device to another across a network, such as the Internet. Audio signals may also be transmitted between components of a computer system or other computing platform, such as between a Digital Versatile Disc (DVD) drive and an audio processor, for example. In such implementations, quality of compressed/decompressed audio signals may be an issue.

Under some circumstances, available audio codecs may utilize one or more lossy signal compression schemes which may allow high signal compression by effectively removing statistical or perceptual redundancies in signals. In such circumstances, decoded signals from a lossy audio compression scheme may not be substantially identical to an original audio signal. For example, distortion or coding noise may be introduced during a lossy audio coding scheme or process, although, under some circumstances, defects may be perceptually reduced, so that processed audio signals may be perceived as at least approximately close to original audio signals. “Audio signals,” as defined herein may comprise electronic representations of audible sounds or data in either digital or analog format, for example.

Under some circumstances, however, lossless coding may be more desirable. For example, a lossless coding scheme or process may allow an original audio signal to be reconstructed from compressed audio signals. Numerous types of lossless audio codecs such as ALAC, MPEG-4 ALS and SLS, Monkey's Audio, Shorten, FLAC, and WavPack have been developed for compression of one or more audio signals.

Various implementations as discussed herein may be based at least in part on one or more lossless compression schemes within a context of a G.711 standard compliant or compatible input signal, such as A-law or μ-law mappings. Some implementations may be employed in voice communication, such as voice communication over an Internet Protocol (IP) network. In this context, μ-law and A-law may refer to logarithmic companding schemes. A μ-law companding scheme may be used in the digital telecommunication systems of North America and Japan, and an A-law companding scheme may be used in parts of Europe, for example. An A-law companding scheme may be used in regions where digital telecommunication signals are carried on certain circuits, whereas a μ-law companding scheme may be used in regions where digital telecommunication signals are carried on other types of circuits, for example.

“Companding,” as used herein may refer to a method of reducing effects of limited dynamic range of a channel or storage format in order to achieve better signal-to-noise ratio or higher dynamic range for a given number of bits. Companding may entail rounding analog signal values on a non-linear scale as a non-limiting example.

In one or more implementations, speech signals represented by 16-bit linear Pulse Code Modulated (PCM) may be mapped to 8-bit G.711 non-linear PCM sample signal values as an example. “PCM,” as used herein may refer to is a digital representation of an analog signal where a magnitude of an analog signal may be sampled regularly at uniform intervals, and may be quantized to a series of symbols in a numeric code. Quantization in this context refers to a process of approximating a continuous range of values (or a large set of possible discrete values) by, for example, a relatively-small (or smaller) set of discrete symbols or integer signal value levels. 8-bit companded PCM sample signals may be transmitted to another device or via a communication network and may be decoded by a G.711 decoder to reconstruct original 16-bit PCM signal sample values, for example.

Lossless compression and decompression for an 8-bit companded or compressed PCM sample mapped by G.711 encoding may be desirable for more efficient usage of network bandwidth. In various digital audio or speech implementations, input signals may be compressed by nonlinear companding. Such compressed signals may be transmitted to and expanded at a receiving end using a non-linear scale related to the nonlinear companding scale.

Companding schemes may reduce a dynamic range of an audio signal. In analog systems, use of companding schemes may increase a signal-to-noise ratio (SNR) achieved during transmission of an audio signal, and in a digital domain, may also reduce a quantization error, thereby increasing a signal-to-quantization noise ratio.

As an example, a logarithmic companding scheme may also be deployed in audio compression found in a Digital Audio Tape (DAT) format, which may convert, while in a Long Play (LP) mode, 16-bit linear Pulse Code Modulation (PCM) signal sample values to 12-bit non-linear signal sample values.

Despite compression gain achieved by companding schemes, there has been a demand for further reducing a signal processing rate of compander based codecs without significantly compromising quality of reconstructed audio. To meet such a demand, a compression scheme may be employed.

One or more implementations may provide for a system or method for implementing compressed domain predictive encoding and decoding. A linear predictor may be utilized to estimate companded domain sample signal values of input signal sample values. A residual of a different between predicted companded signal sample values and actual companded signal sample values may be determined, encoded, and then transmitted to a decoder. A particular scheme for encoding a residual may be selected based at least in part on a variance of residual values for a given set of residuals. By utilizing and transmitting a companded domain residual value, as discussed herein, improved system efficiency or bandwidth may be realized.

Examples of particular implementations will now be described in detail below.

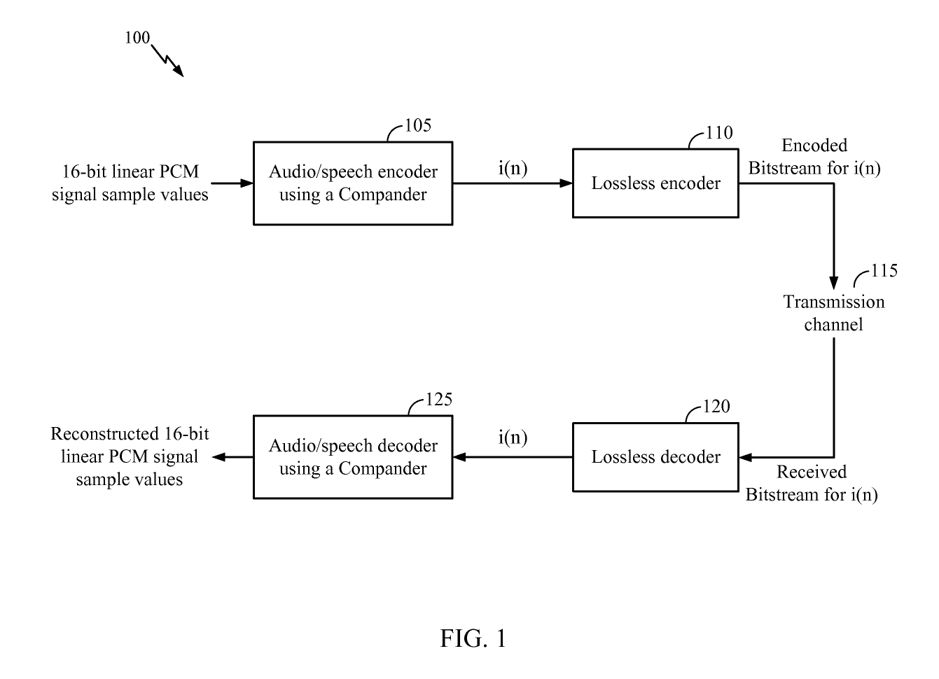

FIG. 1 illustrates a compression and transmission system 100 according to one or more implementations. In FIG. 1, 16-bit linear PCM sample signal values may be provided as input signal sample values to an audio/speech encoder (e.g, compressor) 105 having a compander. Input signal sample values may be companded according to μ-law or A-law schemes. Moreover, such input signal sample values may be compressed to 8- or 12-bit signal sample values. Compressed signal sample values are denoted as i(n) in FIG. 1.

A lossless encoder 110 may encode compressed signal sample values for transmission over a channel. For example, lossless encoder 110 may encode nonlinearly companded 8- or 12-bit PCM sample values. Encoded signal sample values may be transmitted via an encoded bitstream across a transmission channel 115 to a lossless decoder 120. For example, predictor information and code index signal values may be transmitted via an encoded bitstream across transmission channel 115. Lossless decoder 120 may decode received encoded signals to generate 8- or 12-bit compressed PCM sample signal values. Compressed PCM sample signal values may be provided to an audio/speech decoder (e.g., expander) 125 to reconstruct 16-bit linear PCM sample signal values. In some implementations, compression and transmission system 100 may result in reduced channel usage in Voice-Over-Internet Protocol (VoIP) applications, for example.

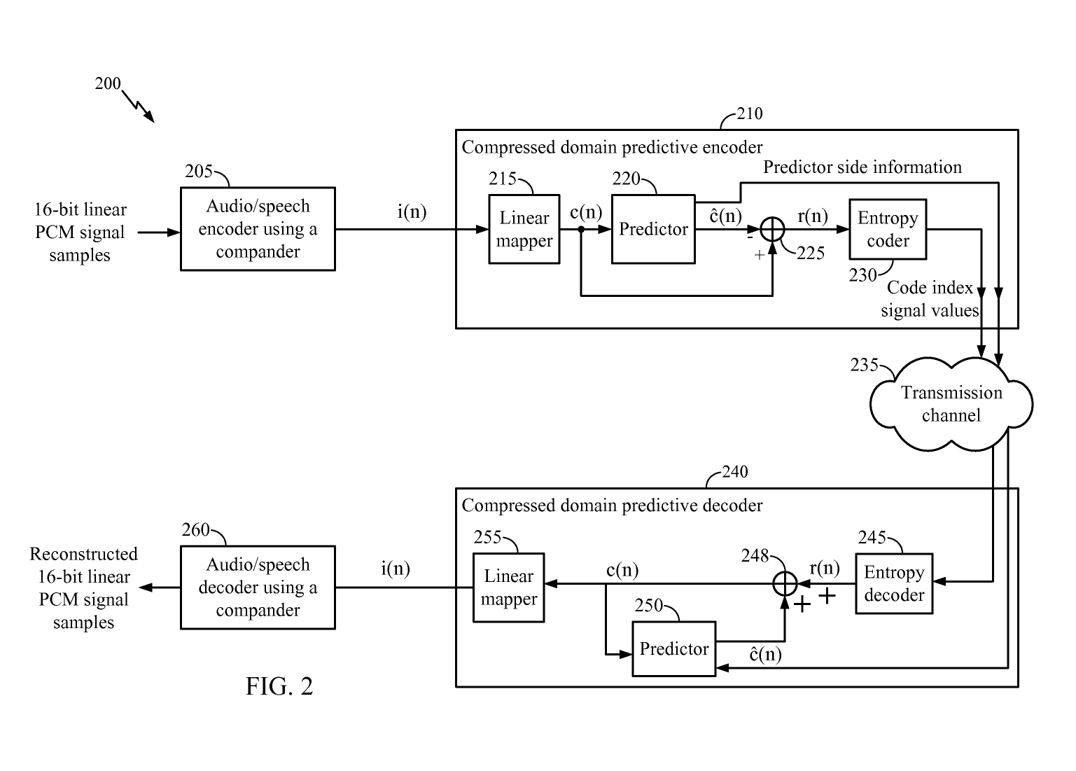

FIG. 2 illustrates a compression and transmission system 200 for compressed audio/speech signal sample values utilizing compressed domain predictive coding according to one or more implementations. Compression and transmission system 200 of FIG. 2 may result in an increased compression gain versus lossless data compression and transmission system 100 shown in FIG. 1.

An audio/speech encoder (e.g., compressor) 205 using a compander may receive 16-bit linear PCM signal sample values and output 8- (e.g., or 12-) bit compressed PCM signal sample values to a compressed domain predictive encoder 210. Compressed PCM signal sample values are denoted in FIG. 2 as i(n). Compressed domain predictive encoder 210 may include a linear mapper 215, a predictor 220, a summer 225, and an entropy coder 230, to name just a few among many possibly components of compressed domain predictive encoder 210. Linear mapper 215 may map input compressed PCM signal sample values i(n) to linearly mapped companded sample signal values denoted as c(n).

Predictor 220 may receive mapped companded sample signal values c(n) and may predict signal sample values of a c(n) as a function of previous signal sample values. Predicted signal sample values of c(n) as determined by predictor 220 are denoted as ĉ(n). Predictor 220 may also output predictor side information which may be used to reconstruct c(n) at a decoder of a receiver, for example. A difference between c(n) and ĉ(n) may be referred to as a “residual” and may be transmitted to a decoder. A combination of ĉ(n) and r(n) may be utilized to reconstruct c(n) at a decoder. A summer 225 may be utilized to determine r(n) by subtracting ĉ(n) from c(n), as shown in FIG. 2. Residual signal sample values r(n) may be provided to an entropy coder 230, which may encode signal sample values and generate code index signal values. Predictor side information and code index signal values may be transmitted by compressed domain predictive encoder 210 through a transmission channel 235 and may be received by compressed domain predictive decoder 240.

Entropy decoder 245 of compressed domain predictive decoder 240 may receive code index signal values and may reconstruct residual sample signal values r(n) based at least in part on the code index signal values. Residual sample signal values r(n) may be added to predicted signal sample values of c(n), denoted as ĉ(n), output by predictor 250 to summer 248. An output of summer 248 may comprise reconstructed mapped companded sample signal values c(n) as illustrated. Predictor 250 may, as part of a feedback loop, receive an input signal sample value c(n) from summer 248 and predictor side information via transmission channel 235 to generate predicted companded sample signal values ĉ(n). Mapped companded sample signal values c(n) may be provided to a linear mapper 255 to reconstruct compressed PCM sample signal values i(n). Finally, audio/speech decoder (expander) 260 may utilize a compander and may reconstruct 16-bit linear PCM sample signal values based at least in part on such input compressed PCM sample signal values.

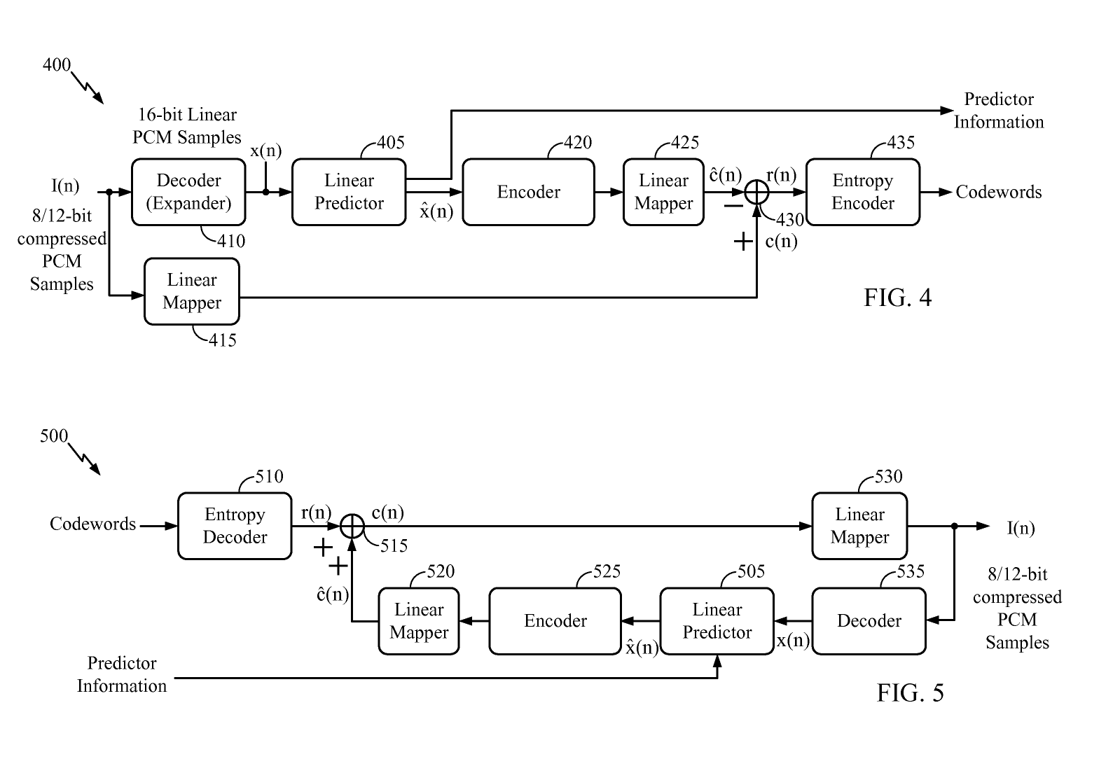

FIG. 2 shows an implementation where a predictor and an entropy coding scheme are incorporated to reduce dynamic range of compressed signal sample values and reduce bit consumption by lossless coding of prediction residuals, respectively. Performance of a lossless compression scheme as shown in FIG. 2 may be based, at least in part, on a design of how a predictor operates on companded signal sample values generated by a nonlinear compander. Due at least in part to nonlinearity of input signals, a nonlinear predictor may be considered a multilayer perceptron predictor, but its implementation may be expensive in terms of computational complexity. Rather than relying on a nonlinear predictor, an implementation as shown in FIGS. 4 and 5, as discussed below, may more efficiently address nonlinearity.

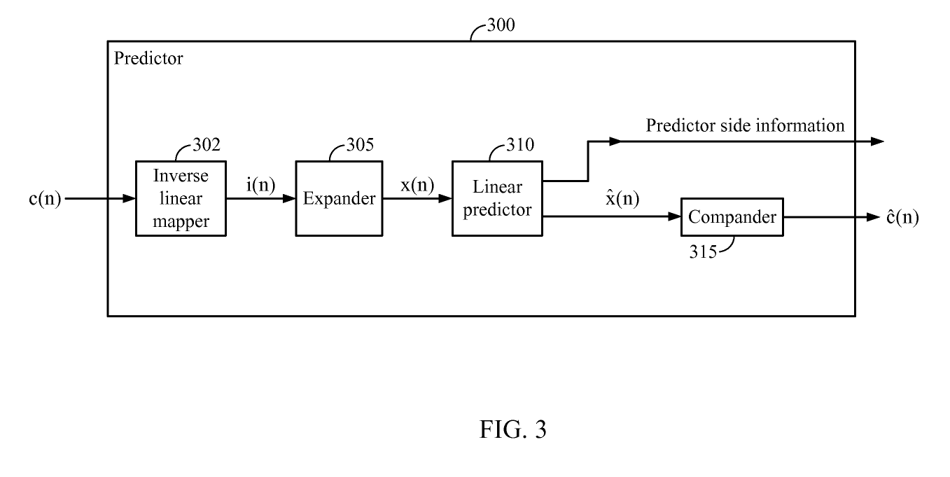

FIG. 3 illustrates a predictor 300 according to one or more implementations. Predictor 300 may be utilized in the place of predictor 220 or predictor 250 shown in FIG. 2. As illustrated, companded input signal sample values c(n) may be provided to an inverse linear mapper 302, which may output compressed PCM sample signal values i(n). Compressed PCM sample signal values i(n) may be provided to an expander 305. Expander 305 may convert compressed PCM sample signal values i(n) to 16-bit linear PCM sample values x(n). 16-bit linear PCM sample values x(n) may be provided to a linear predictor 310 which may perform linear prediction to predict signal sample values \hat{x}(n) and generate predictor side information. Predicted signal sample values \hat{x}(n) may be provided to a compander 315 to generate predicted companded signal sample values ĉ(n).

FIG. 4 illustrates an encoder side of a compression system 400 utilizing a linear predictor 405 according to one or more implementations. Compression system 400 may include a decoder (e.g., expander) 410, linear mapper 415, linear predictor 405, encoder (e.g., decompressor) 420, linear mapper 425, summer 430, and entropy encoder 435. An input signal to compression system 400 may comprise a stream of 8- or 12-bit compressed PCM sample signal values, denoted as i(n) in FIG. 4. Linear mapper 415 may map input 8- or 12-bit compressed PCM sample signal values to linearly mapped companded output signal sample values denoted as c(n). Decoder (expander) 410 may decode or expand input 8- or 12-bit compressed signal sample values to generate 16-bit linear PCM sample signal values denoted as x(n). Linear predictor 405 may predict signal sample values of x(n), denoted as \hat{x}(n) in FIG. 4. Linear predictor 405 may also generate predictor information which may be transmitted to a receiver via a transmission channel, for example, and may be used at least in part by a receiver to reconstruct predicted signal sample values of x(n), denoted as \hat{x}(n), as discussed below with respect to FIG. 5.

Input compressed PCM sample signal values i(n) may be fragmented into a frame of a fixed length N. 8-bit signal sample values in a frame may be expanded to 16-bit signal sample values x(n) by a decoder, such as a G.711 decoder. Given a set of 16-bit PCM sample signal values x(n), an optimum linear predictor may be determined in terms of an order of linear predictor 405 and codewords/coefficients may be determined in a way that reduces a number of output bits for coding of predictor information and prediction residual sample values.

Derived predictor coefficients may be quantized, entropy-coded and sent to a bitstream together with a predictor order. Quantized predictor coefficients and previous signal sample values x(n) in the frame may be utilized to determine predicted signal sample values \hat{x}(n). Predicted signal sample values \hat{x}(n) may be converted to 8-bit signal sample values to perform compander or compressed domain predictive coding by encoder (compressor) 420. In order to reduced a risk of irregular discontinuity on μ- or A-law encoded 8-bit signal sample values, a linear mapping may be applied for μ- or A-law encoding result of a predicted sample \hat{x}(n) by linear mapper 425. “Compressed domain,” as used herein, may refer to a domain after linear mapping of μ- or A-law encoded 8-bit signal sample values. Linearly-mapped 8-bit signal sample values ĉ(n) may be subtracted from c(n) by summer 420 to obtain a prediction residual sample r(n) in an 8-bit compressed domain. For lossless coding of a computed residual sample, r(n) may be interleaved to a positive value, from which a code may be selected by entropy encoder 435 and used to encode the interleaved residual signal sample values. In one example, a Rice code may be selected for encoding. On a decoder side, reverse operations of encoding procedures may be performed for a given bitstream, as discussed below with respect to FIG. 5.

FIG. 5 illustrates a decoder side of a compression system 500 utilizing a linear predictor 505 according to an implementation. Compression system 500 may include an entropy decoder 510, summer 515, linear mapper 520, encoder (e.g., compressor) 525, linear predictor 505, decoder (e.g., expander) 535, and a linear mapper 530. Codewords or coefficients corresponding to an encoding scheme may be received via a transmission channel by entropy decoder 510. Entropy decoder may utilize codewords to reconstruct prediction residual signal sample values r(n) in an 8-bit compressed domain, for example. Prediction residual signal sample values r(n) may be added to linearly-mapped 8-bit signal sample values ĉ(n) by summer 515 to obtain companded domain signal sample values c(n). Companded domain signal sample values c(n) may be provided to linear mapper 530 to recover compressed PCM sample signal values i(n) based at least in part on a linear mapping of companded domain signal sample values c(n).

As shown in FIG. 5, compression system 500 may include a feedback loop to generate linearly-mapped 8-bit signal sample values ĉ(n). Compressed PCM sample signal values i(n) may be provided to decoder (expander) 535 to decode compressed PCM sample signal values and output 16-bit uncompressed signal sample values x(n). Linear predictor 505 may generate predicted 16-bit signal sample values \hat{x}(n) based at least in part on 16-bit uncompressed signal sample values x(n) and predictor information received via a transmission channel. Encoder (e.g., compressor) 525 may compress predicted 16-bit signal sample values \hat{x}(n) to 8-bit compressed predicted signal sample values and linear mapper 520 may map 8-bit compressed signal sample values to generate linearly-mapped 8-bit signal sample values ĉ(n).

As shown in FIGS. 4 and 5, residual signal sample values r(n) may be encoded prior to transmission and decoded after transmission. By encoding residual signal sample values r(n), more efficient signal transmission may be achieved.

A coding scheme for prediction residual may be derived by assuming that a residual signal comprised of residual signal sample values r(n) is piecewise stationary, independent and identically distributed, and a segment may be characterized by double-geometric density:

$$P \text{?} ( r ) = \frac{1 \text{?}}{1 \text{?}} \text{?}$$

$$\text{?} \text{indicates text missing or illegible when filed}$$

where θ comprises a parameter indicative of spread (e.g., variance) of a distribution of residual signal sample values r(n). Residual signal sample values r(n) may be evenly distributed around a value 0, for example.

Parameter θ may be predicted or estimated (a predicted or estimated value of parameter θ shown below is denoted as θ°) from a sample residual subblock of a speech frame

$$θ \text{?} = \frac{- 1 \text{?} \sqrt{1 \text{?} A \text{?}}}{\text{?}}$$

$$where$$

$$A ( \text{?} ) = {\sum }_{\text{?}} \text{?} ( r ) \vert r \vert = {\sum }_{\text{?}}^{1} \vert \text{?} \vert$$

$$\text{?} \text{indicates text missing or illegible when filed}$$

is a first absolute moment of signal sample set [symbol] . As discussed herein, quantities

$$\hat{P} ( r ) = \text{?}$$

$$\text{?} \text{indicates text missing or illegible when filed}$$

denote signal sample-based estimates of probabilities.

Parameter θ may indicate to a decoder in which a type of distribution or Huffman table may be used to decode a signal containing residual signal sample values r(n). Parameter θ may be quantized prior to being transmitted to a decoder, for example. Quantization of parameter θ may result in a quantized parameter denoted as \hat{θ} below.

An amount of redundancy introduced by quantization of θ (e.g., replacing it by some \hat{θ}) may be quantified as

$$\begin{matrix}D ( \text{?} , θ ) = D ( P \text{?} \vert P \text{?} ) - D ( \hat{P} \text{?} \\ = - log \frac{1 - {θ}^{⋒}}{1 + {θ}^{⋒}} + log \frac{1 - θ}{1 + θ} - A ( \hat{P} ) log \frac{\text{?}}{θ} \\ = - log \frac{1 - {θ}^{⋒}}{1 + {θ}^{⋒}} + log \frac{1 - θ}{1 + θ} - 2 \frac{θ}{\text{?}} log \frac{\text{?}}{θ}\end{matrix}$$

$$\text{?} \text{indicates text missing or illegible when filed}$$

The relation shown above may be used to define a set of reconstruction points [symbol] and boundaries [symbol] in some implementations such that

$$max \text{?} D ( θ , \text{?} ) \leq \text{?}$$

$$\text{?} \text{indicates text missing or illegible when filed}$$

for some given parameter δ.

A total number of reconstruction points to cover an interval θ∈(θₘᵢₙ, θₘₐₓ]⊂(0, 1) with an above bound on redundancy becomes

$$O ( \frac{1}{\text{?}} ) . \\ \text{?} \text{indicates text missing or illegible when filed}$$

Accordingly, a total redundancy of encoding, comprising of transmission of both (a) an index of a region t(θ°) such that [symbol] ; and (b) a signal sample set [symbol] encoded by assuming density with parameter \hat{θ}, may be defined as:

R(n)˜log i(θ°)+n δ²/2˜−log δ+n δ²/2+O(1)

R(n) in the relation above is representative of redundancy.

In some implementations, a minimum value for R(n) may be achieved if [symbol] .

In one or more implementations, a code may be designed in accordance with G.711 and parameters may be set. A number of quantization points (e.g., centroids) and a block size n may be different. In an example discussed below, a block size n=100 is utilized, although it should be appreciated that a different block size may be utilized in some implementations. Parameter δ may be derived and a set of reconstruction points may be produced.

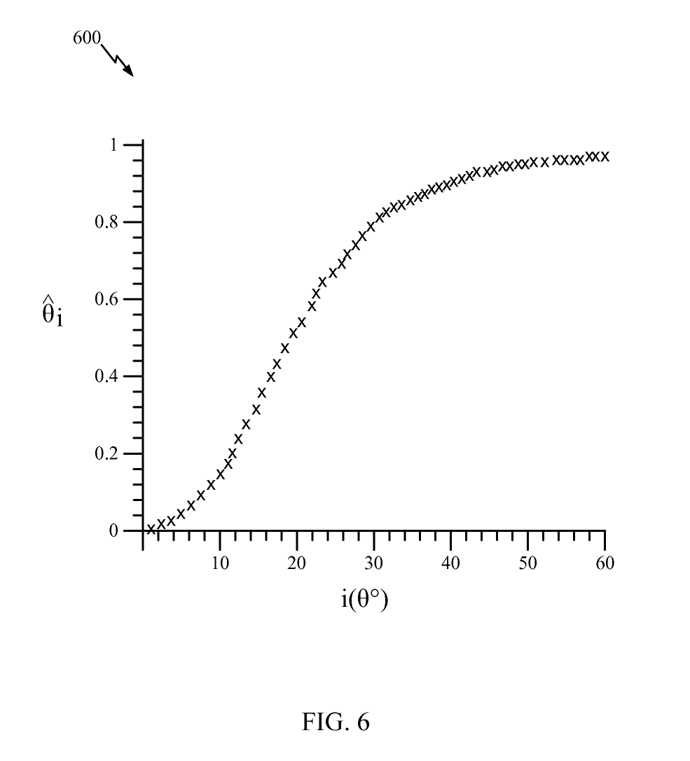

FIG. 6 illustrates a chart 600 of a set of reconstruction points for different index signal values according to one or more implementations. A horizontal axis shows different index (i) values, and a vertical axis shows different possible values for parameter θ° for various index values. Accordingly, chart 600 shows 60 different quantization values of [symbol] . Values of t(θ°) shown in chart 600 may correspond to a particular value of parameter θ°. Therefore, if a value of t(θ°) is transmitted, a receiver may recover a corresponding value [symbol] of the parameter θ° based at least in part on a relationship between t(θ°) and θ°, as shown in chart 600, for example.

An index of distribution t(θ°) and actual signal sample values may be encoded, for example, by using entropy coding tables such as Huffman code tables and transmitted to a receiver. A particular Huffman code may be selected based at least in part on variance of distribution as indicated by the reconstructed parameter [symbol] as an example. For example, different Huffman codes may be suitable for different values of parameter \hat{θ}. Accordingly, if transmitting encoded signal sample values or other data or information, information indicative of a particular Huffman code table to be used to decode encoded signal sample values may be transmitted. In an example, a value of t(θ°) may be transmitted and utilized to determine a corresponding value of parameter \hat{θ}. After a corresponding value of parameter \hat{θ} has been determined, a Huffman code corresponding to parameter \hat{θ} may be determined and encoded signal sample values may be decoded.

A compact design of Huffman tables corresponding to distributions [symbol] may be determined based on symmetry and other properties of such distributions.

Both sides of distributions may be folded (e.g., by remove +or − signs), producing quantities [symbol] with model density

$$P ( x \text{?} ) = [ \begin{matrix}\text{?} & if x \text{?} = 0 \\ 2 \text{?} θ \text{?} & if x \text{?} > 0\end{matrix} P ( r \text{?} ) = [ \begin{matrix}\text{?} & if r \text{?} = 0 \\ 2 \text{?} θ \text{?} & if r \text{?} > 0\end{matrix} \\ \text{?} \text{indicates text missing or illegible when filed}$$

For large values of [symbol] (e.g. [symbol] ), distributions may become wide. To compact Huffman tables with a large value of [symbol] , adjacent values in distributions may be further grouped into single entries in Huffman tables.

For example, codes may be created corresponding to groups of 2^{k} values, distinguishable by transmission of an extra k bits, for example. To produce groups, a constraint on redundancy of a group may be imposed such that:

$$R ( i , k ) - k = log {P}_{2} ( i , k ) + {\sum }_{\text{?}}^{ } log P ( \text{?} ) \leq 0$$

$${P}_{2} ( L , k ) = {\sum }_{\text{?} - 1}^{ } P ( j ) = 2 \text{?} θ \text{?}$$

$$\text{?} \text{indicates text missing or illegible when filed}$$

and δ is some parameter.

For example, by using a criterion

$$δ = \frac{1}{\text{?}} log n {\text{?}}_{= 160} 0.0228$$

$$\text{?} = \frac{1}{\text{?}} log n {\text{?}}_{= 100} 0.0228 , \\ \text{?} \text{indicates text missing or illegible when filed}$$

and assuming a large θ, Table 1 shown below may be generated:

TABLE 1

| Group | | Group |
|---|---|---|
| class | Starting index i | size 2^{k} |
| 1 | 1 | 1 |
| 2 | 34 | 2 |
| 3 | 67 | 4 |
| 4 | 139 | 8 |
| . . . | | |

Table 1 may indicate an alphabet grouping indicating a number of bits to utilize to transmit an index value. Instead of utilizing a fixed number of bits to transmit an index regardless of a value of the index, a smaller number of bits may be utilized based at least in part on a value of the index in one or more implementations. A particular grouping of an index indicates how many extra bits to extract from bitstream to decode an index value.

Group class 1 indicates a grouping of different index values. A code corresponding to a index value within group class 1 may be transmitted via a small amount of bits needed to represent a code. In this example, a single code value may be transmitted for indexes having values between 1 and 33. “Group size” in the table above indicates how many extra bits to extract from a bitstream to distinguish between codes used to represent indexes between 1 and 33. In this example, one extra bit may be extracted from a bitstream to distinguish between indexes between 1 and 33. If, however, an index value between 34 and 66 is to be transmitted, one extra bit may need to be extracted from a bitstream.

For small [symbol] (in cases with indices i<=11, for example) distributions may become very “spiky” (and almost singular for i=0), making them potentially unsuitable for code construction. For small [symbol] , codes for blocks of 10 indicators may be designed as follows:

$$χ ( \text{?} ) = [ \begin{matrix}0 , & if \text{?} = 0 \\ 1 & if \text{?} \neq 0\end{matrix} r ( \text{?} ) = [ \begin{matrix}0 , & if \text{?} = 0 \\ 1 & if \text{?} \neq 0\end{matrix} \\ \text{?} \text{indicates text missing or illegible when filed}$$

For those [symbol] whose indicators are 1, additional codes may be transmitted for zero-removed partial distributions:

$$P ( {x}^{++} ) = \frac{1}{1 - \frac{\text{?} - \text{?}}{\text{?} + \text{?}}} 2 \frac{\text{?} - \text{?}}{\text{?} + \text{?}} θ {\text{?}}^{++} , \\ {x}^{++} = 1 , 2 , … P ( {r}^{++} ) = \frac{1}{1 - \frac{\text{?} - \text{?}}{\text{?} + \text{?}}} 2 \frac{\text{?} - \text{?}}{\text{?} + \text{?}} θ {\text{?}}^{++} , \\ {r}^{++} = 1 , 2 , …$$

$$\text{?} \text{indicates text missing or illegible when filed}$$

Overall, using techniques as described above, a set of Huffman tables may be generated that achieve redundancy that is within 0.03% of entropy estimates, for example, over a signal set, and which are still sufficiently compact to fit in 2K memory entries, a target for G.711 memory usage. An encoding scheme as described above may employ a single pass over a signal set, unlike some schemes in G.711, which may employ four passes and trying different sets of Huffman tables.

Referring back to FIGS. 4 and 5, one or more implementations may utilize compressed domain predictive coding, with some modifications incorporated to improve coding gain. For example, within a linear prediction block, a predictor order and coefficients may be determined by a search that takes into account an impact on bit rate changes by blocks coming after linear prediction.

In an implementation for compressed domain predictive coding, forward adaptive linear prediction may be employed to reduce a dynamic range of input signal sample values. Among various approaches to implement linear prediction, linear prediction may be implemented with Finite Impulse Response (FIR) filters which may estimate a current sample r(n) as

$$\text{?} ( n ) = {\sum }_{k = 1}^{P} {a}_{k} r ( n - k ) , 0 ≦ n < N$$

$$\text{?} \text{indicates text missing or illegible when filed}$$

where P and aₖ respectively denote an order and coefficient of a prediction filter, for example.

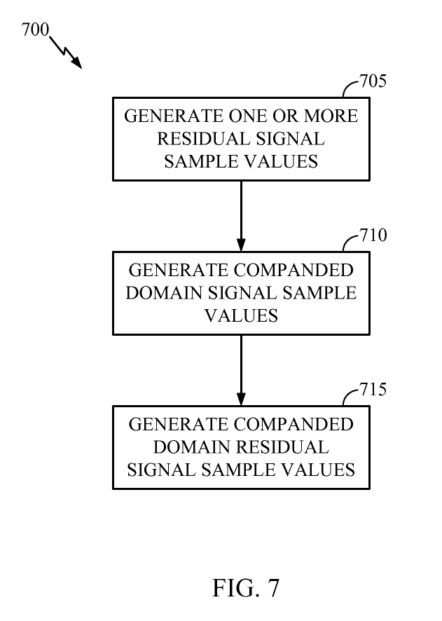

FIG. 7 illustrates a process 700 for determining companded domain residual signal sample values according to one or more implementations. For example, a process may be implemented by a compressed domain residual encoder, for example. First, at operation 705, one or more residual sample signal values may be generated. Residual sample signal values may be generated based at least in part on linear predication coding using linear prediction coefficients. At operation 710, one or more companded domain signal sample values may be generated. For example, one or more companded domain signal sample values may be generated based at least in part on input sample values. Finally, at operation 715, companded domain residual signal sample values may be generated based at least in part on companded domain signal sample values.

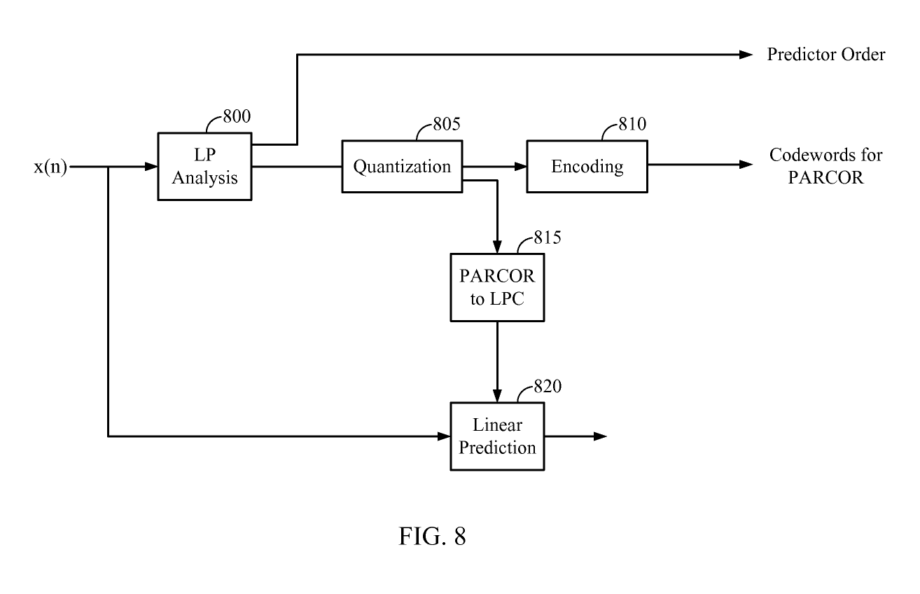

FIG. 8 illustrates a functional flow of operations within a linear predictor, such as within linear predictor 405 shown in FIG. 4, according to one or more implementations. From 16-bit signal sample values x(n), an LP analysis block 800 may determine, for example, a predictor order and coefficients via a Levinson-Durbin process which may recursively computes reflection coefficient Kₘ and a variance of prediction residuals for a predictor order. Once a predictor order is determined, reflection coefficients may be quantized in quantization block 805 to generate quantization indexes. Quantization indexes may be encoded in encoding block 810 and may be sent to a bitstream to provide a decoder with predictor information. In one or more implementations, encoding block 810 may employ Rice code quantization indexes.

At a decoder, quantized reflection coefficients may be decoded and converted to a quantized version of predictor coefficients via a block “PARCOR to LPC” 815. Partial Correlation Coefficients (PARCOR) for quantization indexes may be converted to Linear Prediction Coefficients (LPC) by PARCOR to LPC block 815. Using predictor coefficients, predicted signal sample values \hat{x}(n) may be computed by linear prediction block 820, converted to a compressed domain and added with decoded prediction residuals. For example, operations may be performed at an encoder to produce virtually identical prediction residuals in both an encoder and a decoder.

An aspect of forward-adaptive prediction includes determining a suitable prediction order, as an adaptive choice of a number of predictor taps may be beneficial to account for time-varying signal statistics and to reduce an amount of side information associated with transmitting sets of coefficients. While increasing an order of a predictor may successively reduce a variance of prediction signal errors and lead to smaller bits Rₑ for a coded residual, bits R_{c} for predictor coefficients, on the other hand, may rise with a number of coefficients to be transmitted. Thus, a task is to find an order which reduces a total number of bits

Rₜ(m)=Rₑ(m)+R_{c}(m)

with respect to a prediction order m for 1≦m≦Pₘₐₓ, where Pₘₐₓ is a pre-determined predictor order.

A search for a reduced order may be carried out relatively efficiently by implementing a Levinson-Durbin process. For an order m, a set of predictor coefficients may be calculated, from which an expected bits for coefficients R_{c}(m) may be roughly predicted. Moreover, a variance of corresponding residuals may be determined, resulting in an estimate of residual coding Rₑ(m). Residual coding Re(m) may be approximated with a number of bits used for binary coding of a residual, in accordance with:

$${R}_{e} ( m ) \approx \frac{1}{2} {log}_{2} E ( m ) ,$$

where E(m) is representative of energy of a prediction residual at an m-th order predictor. Together with R_{c}(m), a total number of bits may be determined for an iteration, and thus a reduced order may be found such as

$${P}^{*} = arg {min}_{m} \{ {R}_{e} ( m ) + {R}_{c} ( m ) \} .$$

Prediction residuals may be computed in a 8-bit compressed domain in one or more implements. μ- or A-law encoded 8-bit signal sample values may show discontinuity between two signal sample values that are even very close in a 16-bit PCM domain. For example, an μ-law encoder may map two 16-bit PCM sample signal values, +1 and −1, to 8-bit indexes 255 and 127, respectively. If a predictor estimates an original sample x(n)=1 with \hat{x}(n)=−1 in a 16-bit PCM domain, a differential of an estimate in an μ-law compressed domain may be 128, which may consequently employ many bits in coding. To reduce such occurrences, μ- or A-law encoded 8-bit signal sample values may be re-assigned to continuous values via linear mapping. For this, linear mapping may be utilized such as:

$$c ( n ) = \{ \begin{matrix}255 - i ( n ) , & if i ( n ) > 127 \\ i ( n ) - 128 , & if i ( n ) \leq 127.\end{matrix}$$

for μ-law encoded signal sample values. For an A-law coded input signal, even bits of an A-law encoded sample i(n) may be inverted and an inverted signal sample value i′(n) may be mapped to

$$c ( n ) = \{ \begin{matrix}{i}^{′} ( n ) - 128 , & if {i}^{′} ( n ) > 127 \\ - {i}^{′} ( n ) - 1 , & if {i}^{′} ( n ) \leq 127.\end{matrix}$$

An μ-law decoder may be defined to expand both 8-bit signal sample values i(n)=255 and i(n)=127 to one 16-bit PCM sample x(n)=0. If lossless compression is utilized for exact reconstruction in a 16-bit PCM domain (not in an μ-law encoded domain), it may be unnecessary to allow linear mapping to assign both 8-bit signal sample values to different values c(n)=0 and c(n)=−1. In this case, further compression gain for μ-law encoded 8-bit signal sample values may be achieved by adopting a modified linear mapping such as

$$c ( n ) = \{ \begin{matrix}255 - i ( n ) , & if i ( n ) > 127 \\ i ( n ) - 127 , & if i ( n ) \leq 127.\end{matrix}$$

where both i(n)=255 and i(n)=127 are assigned to c(n)=0. A mapping may, however, result in decoding ambiguity. If c(n)=0, an inverse linear mapping used in a decoder may consider i(n)=255 and i(n)=127 as a mapped value but may not determine to which value of two candidates it should be assigned. A decoding ambiguity, however, may be handled after μ-law decoding, because both candidates may be decoded to x(n)=0, regardless of to which value c(n)=0 is assigned. A way of linear mapping may be beneficial, especially for coding of intermittent silence intervals, where, for example, frames are filled with two signal sample values i(n)=255 and i(n)=127, depending on a level of background noise. Instead of spending bits during encoding of a given frame to fill with two values, a frame (after assigning two values to 0) may be more economically signaled with an “all zero” flag.

After an N-sample block of prediction residual signal sample values in a 8-bit compressed domain has been obtained, it may be applied to encoding at encoding block 810 shown in FIG. 8. Likewise, a negative side of an integer residual r(n) may be flipped and merged with a positive integer residual. An interleaving process may be accomplished as

$${r}^{+} ( n ) = \{ \begin{matrix}2 r ( n ) , & if r ( n ) \geq 0 \\ - 2 r ( n ) - 1 , & if r ( n ) < 0.\end{matrix}$$

Encoding of a positive integer n with a code parameter k, such as by Rice coding, or another coding scheme, may comprise two parts: (a) unary coding of quotient └n/2^{k}┘ and (b) binary coding of k least significant (LS) bits. In an example where n=11 (‘1011’), coding, such as Rice coding, with k=2 may yield ‘00111’, that is, a unary coding of quotient 2 (‘001’) and 2-bit coding for remainder 3 (‘11’). If a Rice code parameter is selected as k=1, an integer may be encoded in this case as 8-bit codeword ‘0000011’. From this example, it may be seen that (a) Rice coding of integer n with parameter k may yield └n/2^{k}┘+k+1 bits, and (b) for a given set of non-negative integers, there may be a Rice parameter that produces a reduced number of bits. Given an N-sample block of an interleaved prediction residual, a Rice coding parameter may be selected such as

$${k}^{*} = arg {min}_{k} \{ {\sum }_{n = 0}^{N - 1} ⌊ \frac{{r}^{+} ( n )}{{2}^{k}} ⌋ + ( k + 1 ) N + ( k + 1 ) \} ,$$

where a last term in a relation above may account for bits for unary coding of parameter k. Instead of relying on unary coding of a Rice code parameter, one may instead employ another Rice code that has a parameter greater than 0. In this example, a last term in the relation may be appropriately changed.

One simple solution for parameter selection was adopted in Moving Picture Experts Group Audio Lossless Coding (MPEG-ALS), where a mean of absolute values of prediction residuals may be computed and applied for an estimate of a parameter

$$k = ⌊ {log}_{2} μ + 0.97 ⌋ , \\ where$$

$$μ = \frac{1}{N} {\sum }_{n = 0}^{N - 1} \vert r ( n ) \vert .$$

A simple technique to improve coding gain may be incorporated in a Rice coding procedure. Particularly, if zeros-state FIR filtering is enforced in some applications, a few signal sample values at a beginning of a frame may be predicted from previous values that are assumed to be zero. Hence, prediction residuals at beginning positions may have larger magnitude than other signal sample values, potentially leading to relatively poor compression efficiency. To mitigate this, two Rice codes may be employed—if a predictor order and Rice code are selected as P and k respectively, first P residuals may be encoded by Rice code with parameter k+1, while all remaining residuals may be Rice coded with parameter k.

While an aforementioned procedure for predictor order selection may allow for efficient search for a predictor order, suboptimal selection of predictor order may sometimes occur, especially if a length of input data is not long enough to compute accurate statistics. In an example, theoretical estimates of total bits may be substituted with a number of bits produced by Rice-coding of computed reflection coefficients and a residual. Substitutions may, however, involve intensive computations, because FIR filtering may be performed with newly computed predictor coefficients at a predictor order to reconstruct predicted values. Prediction residual values may be obtained from predicted values while its bits may be derived by taking into account a Rice coding procedure.

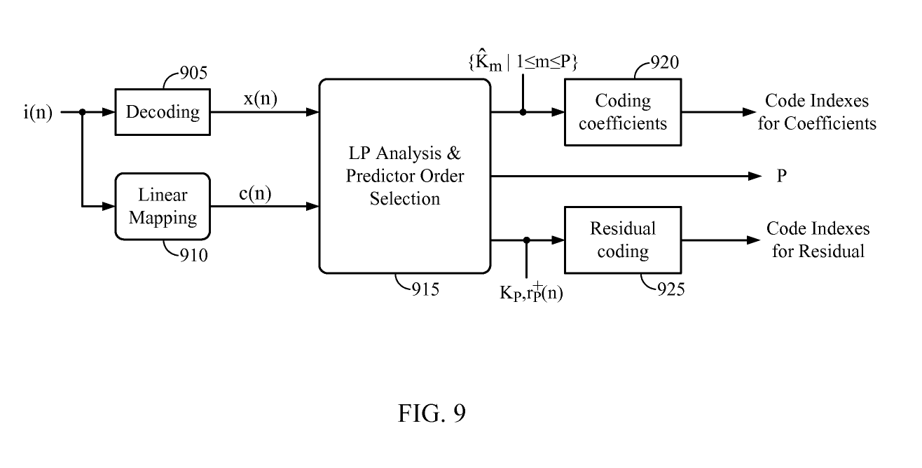

FIG. 9 illustrates a system 900 for implementing a compression scheme that incorporates order selection into a linear prediction analysis structure discussed above with respect to FIG. 8 according to one or more implementations. System 900 may lift computational burdens associated with a search for optimal predictor order. As shown, compressed 8-bit PCM sample signal values i(n) may be decoded by a decoding block 905 to generate 16-bit PCM sample signal values x(n). Compressed 8-bit PCM sample signal values i(n) may be mapped by a linear mapping block 910 to generate compressed or companded domain signal sample values c(n).

Signal sample values x(n) and c(n) may be provided to a linear prediction (LP) analysis and predictor order selection block 915. From given μ- or A-law encoded signal sample values in a frame, LP analysis and predictor order selection may be performed. Once a predictor order P has been selected, reflection coefficients and compressed domain prediction residual at a P-th order predictor, which may have previously been computed during an order selection procedure, may be forwarded to respective encoding modules, such as coding coefficients block 920 and residual coding block 925. As discussed above, encoding modules may implement Rice coding, for example.

An order selection scheme may adopt a lattice predictor that may have a relatively efficient structure for generating a prediction residual, thereby reducing computations for FIR filtering to compute predicted signal sample values.

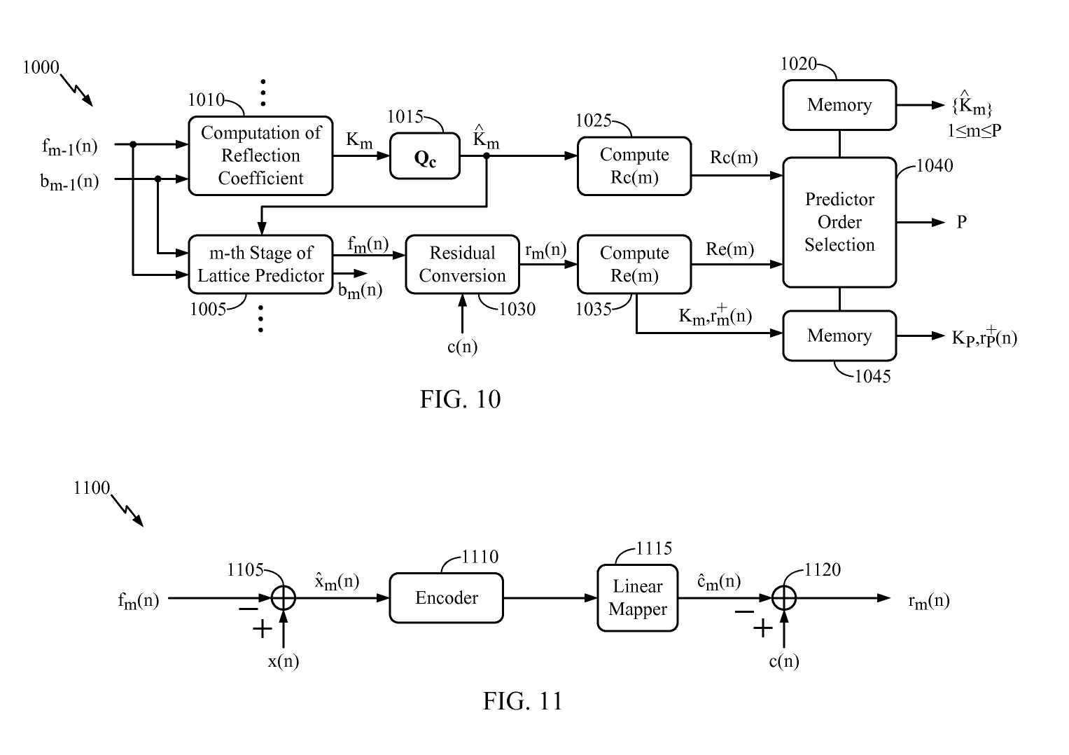

FIG. 10 illustrates a functional block diagram of a linear prediction process 1000 according to one or more implementations. In FIG. 10, fₘ(n) and bₘ(n) denote respectively forward and backward prediction signal errors by an m-th stage of a lattice predictor 1005. A reflection coefficient block 1010 may receive forward and backward prediction signal errors for a previous signal sample values, e.g., fₘ₋₁(n) and bₘ₋₁(n) and may compute a reflection coefficient K_{m.} For a predictor order m=1, 2, . . . , Pₘₐₓ, reflection coefficients Kₘ may be computed from forward and backward prediction signal errors as

$${κ}_{m} = \frac{{\sum }_{n = 0}^{N} {f}_{m - 1} ( n ) {b}_{m - 1} ( n - 1 )}{{\sum }_{n = 0}^{N} {f}_{m - 1}^{2} ( n ) {\sum }_{n = 0}^{N} {b}_{m - 1}^{2} ( n - 1 )} .$$

and may be applied to quantization and coding procedures. For example, reflection coefficients Kₘ may be utilized to generate quantized values. Instead of relying on uniform quantization of reflection coefficients, reflection coefficients may be companded by a compander function and quantized by a simple 5-bit uniform quantizer at quantization block 1015, for example. This may result in values such as:

$${\hat{κ}}_{1} = \frac{1}{16} \{ ⌊ 16 ( 1 - \sqrt{2 - 2 {k}_{1}} ) ⌋ + 0.5 \} , \\ {\hat{κ}}_{2} = \frac{1}{16} \{ ⌊ 16 ( - 1 + \sqrt{2 + 2 {k}_{2}} ) ⌋ + 0.5 \} .$$

Remaining coefficients Kₘ for m>2 may not companded, but may instead be simply quantized using a 7-bit uniform quantizer as

\hat{K}ₘ=(└64Kₘ┘+0.5)/16.

Values of \hat{K}ₘ may be stored in a memory at memory storage block 1020.

Quantization indexes may be re-centered around more probable values, encoded using Rice codes, from which a number of bits for coding a reflection coefficient R_{c}(m) may be computed at compute R_{c}(m) block 1025. By adding R_{c}(m) with bits R_{c}(m−1) from a previous stage, bits R_{c}(m) may be obtained for coding coefficients of an m-th predictor. Quantized reflection coefficient \hat{K}ₘ may be forwarded to a predictor order selection block 1040. For example, an order of m may be more efficiently selected by taking advantage of a lattice predictor structure. From \hat{K}ₘ, forward and backward prediction signal errors by an m-th order predictor may be recursively computed in an m-th stage of the lattice predictor as

fₘ(n)=fₘ₋₁(n)−\hat{K}ₘbₘ₋₁(n−1),

bₘ(n)=bₘ₋₁(n−1)−\hat{K}ₘfₘ₋₁(n),

Where, as discussed above, fₘ(n) and bₘ(n) denote respectively forward and backward prediction signal errors by an m-th stage of a lattice predictor 1005. A computed residual in a 16-bit PCM domain may be converted to the 8-bit compressed domain representation rₘ(n) in the residual conversion block 1030. This block is described in detail at FIG. 11.

FIG. 11 is a system 1100 for residual signal conversation according to one or more implementations. A summer 1105 may subtract a computed prediction residual fₘ(n) from a sample x(n) from an m-th order predictor to generate a predicted value \hat{x}ₘ(n)=x(n)−fₘ(n). Predicted signal sample values \hat{x}ₘ(n) may be μ- or A-law compressed by encoder 1100. For example, encoder 1100 may encode predicted signal sample values \hat{x}(n) in accordance with G.711. Encoded signal sample values from encoder 1110 may be mapped by linear mapper 1115 to generate companded sample signal values ĉₘ(n). A prediction residual rₘ(n) in an 8-bit compressed domain may be obtained by subtracting ĉₘ(n) from c(n) by summer 1120.

Referring black to FIG. 10, prediction residual rₘ(n) may be provided to an Rₑ(m) computation block 1035 to determine a number of bits Rₑ(m) for encoding of value rₘ(n). From a given residual in an 8-bit compressed domain, an encoding parameter, such as a Rice coding parameter kₘ in one or more implementations utilizing Rice coding, may be determined by a process as discussed above. Also, a residual rₘ(n) may be interleaved to a non-negative version rₘ⁺(n). With a derived kₘ and rₘ⁺(n), a number of bits for Rice-coding of a residual may be computed as

$${R}_{e} ( m ) = {\sum }_{n = 0}^{m - 1} ⌊ \frac{{r}_{m}^{+} ( n )}{{2}^{{k}_{m} + 1}} ⌋ + {\sum }_{n = m}^{N - 1} ⌊ \frac{{r}_{m}^{+} ( n )}{{2}^{{k}_{m}}} ⌋ + ( {k}_{m} + 1 ) N + m + {k}_{m} + 1.$$

Computed bits Rₑ(m) tor residual coding, together with bits Rₑ(m) for coefficient coding, may be forwarded to optimal predictor order selection block 1040, where a total number of bits Rₜ(m) may be compared against bits at a previous stage. If a current order results in less bits than a previous order, e.g., Rₜ(m)<Rₜ(m−1), then computed values at a current order, kₘ and rₘ⁺(n), may be stored in a local memory 1045. Values may be provided for Rice coding if a current order is at a local minimum value, which may be verified by repeating a procedure as described in FIG. 11 and comparing a total number of bits for a few predictor orders. If a current order renders more bits than a previous order, an iteration may be continued to a predictor order.

A lattice predictor, as discussed above, may provide computational efficiency. Moreover, presence of a backward prediction signal error may also be valuable. Although it can be theoretically proven that variance of forward prediction signal errors may be equal to variance of backward prediction signal errors, it may be observed that bits for Rice-coding prediction signal errors are sometimes different, especially if a length of input signal values is not long enough to compute accurate statistics. Thus, by selecting a prediction process that yields fewer bits, some extra coding gain may be achieved. To achieve coding gain, for example, two blocks of residual conversion and bit computation may be deployed in accordance with a process implemented by a system shown in FIG. 11 and may be performed with backward prediction signal error bₘ(n) to compute bits for Rice-coding. Letting Rₑ^{f}(m) and Rₑ^{f}(m) respectively denote bits for Rice-coding of forward and backward prediction residuals in a 8-bit compressed domain, for example, bits for a prediction residual at an m-th order predictor may be expressed as

Rₑ(m)=min{Rₑ^{f}(m), Rₑ^{b}(m)}+1,

where a value of 1 in this relation is meant for a flag bit for a prediction direction.

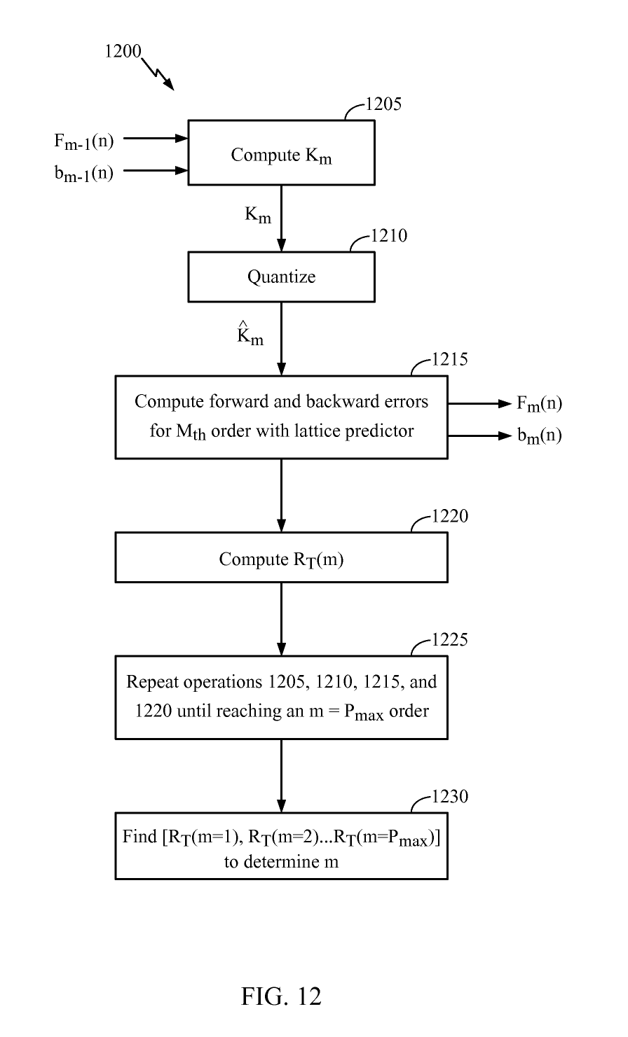

FIG. 12 illustrates a process 1200 for determining an order of a linear predictor according to one or more implementations. At operation 1205, forward and backward prediction signal errors for previous signal sample values, denoted as fₘ₋₁(n) and bₘ₋₁(n), may be received and reflection coefficient kₘ may be computed. At operation 1210, reflection coefficient kₘ may be quantized to determine quantized reflection coefficient \hat{K}ₘ. At operation 1215, forward and backward prediction signal errors, denoted as fₘ(n) and bₘ(n), may be computed for an Mth order with a lattice predictor. At operation 1220, a total number of bits of a residual value Rₜ(m) may be computed. Rₜ(m) indicates the total number of bits in coding residual values and predictor information. At operation 1225, operations 1205, 1210, 1215, and 1220 may be repeated until a predefined maximum order value, denoted as P_{Max}, has been reached. At operation 1230, a minimum value of Rₜ(m) for all values of m between 1 and P_{Max} is determined and a value of m corresponding to a minimum value or Rₜ(m) may be selected as an order for a linear predictor.

A bitstream for a frame may begin with a predictor order that is binary-coded in 4 bits. A variable length bit field may follow for Rice codewords of reflection coefficients. After that, one bit flag field may be presented to indicate a prediction direction for a frame. In a bit field for Rice codewords of prediction residual, a unary code for Rice parameter may be filled before a bit field for Rice codewords of a prediction residual. After writing all bits for a frame, some numbers of zeros may be padded at an end of a bitstream for byte-alignment.

Although 4 bits may be prepared for binary coding of a predictor order, two slots may be reserved for signaling of some special cases. Even though a lossless compression scheme may generally achieve a certain amount of coding gain, there may be some abnormal cases where a compressed bitstream of a frame has more bits than a size of an original raw frame, e.g., 8N bits. In an example, it may be more economic to pack uncompressed 8-bit signal sample values in a frame into a bitstream with minimal overhead that is meant to inform a decoder. In an example, a 4-bit signal such as ‘0001’ may be utilized at a beginning of a frame bitstream.

In addition to 8-bit block coding, another special handling may be designed to save more bits for a frame that is filled with zero-valued sample, e.g., c(n)=0. While Rice coding of an “all-zero” frame may yield more than N bits, a special signaling of a presence of “all-zero” frame may provide an efficient way of frame representation that may only cost a few bits. For this reason, a first slot “0000” may be reserved to signal such an event.

Due to 14 remaining slots for binary coding of prediction order, a search for a predictor order may be performed up to 13. An offset of 2 may be added to a selected predictor order, a result of which may be binary-coded in 4 bits.

In one or more implementations, a Voice Activity Detector (VAD) may be utilized for compressed-domain predictive coding. FIG. 13 is a functional block diagram of a process 1300 for coding according to one or more implementations. For example, a process shown in FIG. 13 may be implemented for μ- or A-law encoded PCM sample signal values.

In FIG. 13, input signal sample values i(n) may be fragmented into a frame of a fixed length N. Signal sample values in a frame may be applied a linear predictor to reduce a dynamic range of input signal sample values. Forward adaptive linear prediction and its preceding linear predictor coefficient (LPC) analysis may be performed in different modes, for example, with input data represented in different domains.

Input signal sample values i(n) may be mapped via linear mapping block 1305 to generate compressed sample signal values c(n). For example, compressed sample signal values c(n) may formatted in a compressed or companded domain. A VAD block 1310 may detect a presence of audio sounds within compressed domain signal sample values c(n) and may determine whether a frame contains active speech. VAD block 1310 may utilize a frame classifier to analyze compressed domain signal sample values c(n) signal sample values by measuring and comparing a zero-crossing rate and signal energy. If a measurement of audio sounds in signal sample values is below a predefined threshold level, VAD block 1310 may direct a switch 1312 to provide compressed domain signal sample values c(n) to a low order linear prediction block 1315. On the other hand, if a measurement of audio sounds in signal sample values is equal to or greater than a predefined threshold level, VAD block 1310 may direct switch 1312 to provide original input signal sample values i(n), instead of compressed domain signal sample values c(n), to a high order linear prediction block 1320. High order linear prediction block 1320 may include a compander so that signal sample values output are formatted in a compressed domain.

After computing predicted signal sample values in the compressed domain by one of two LP schemes, switch 1325 may be directed to provide predicted compressed domain signal sample values ĉ(n) to a summer to be added to compressed domain signal sample values c(n) to generate residual signal sample values r(n). Residual values r(n) may be encoded and transmitted to a receiver. In one or more implementations, such as shown in FIG. 13, a Rice coding block 1335 may be utilized to encode residual signal sample values r(n). A frame type, as characterized by VAD block 1310, may be determined and predictor information from low order linear predictor block 1315 or from high order linear predictor block 1320 may be determined.

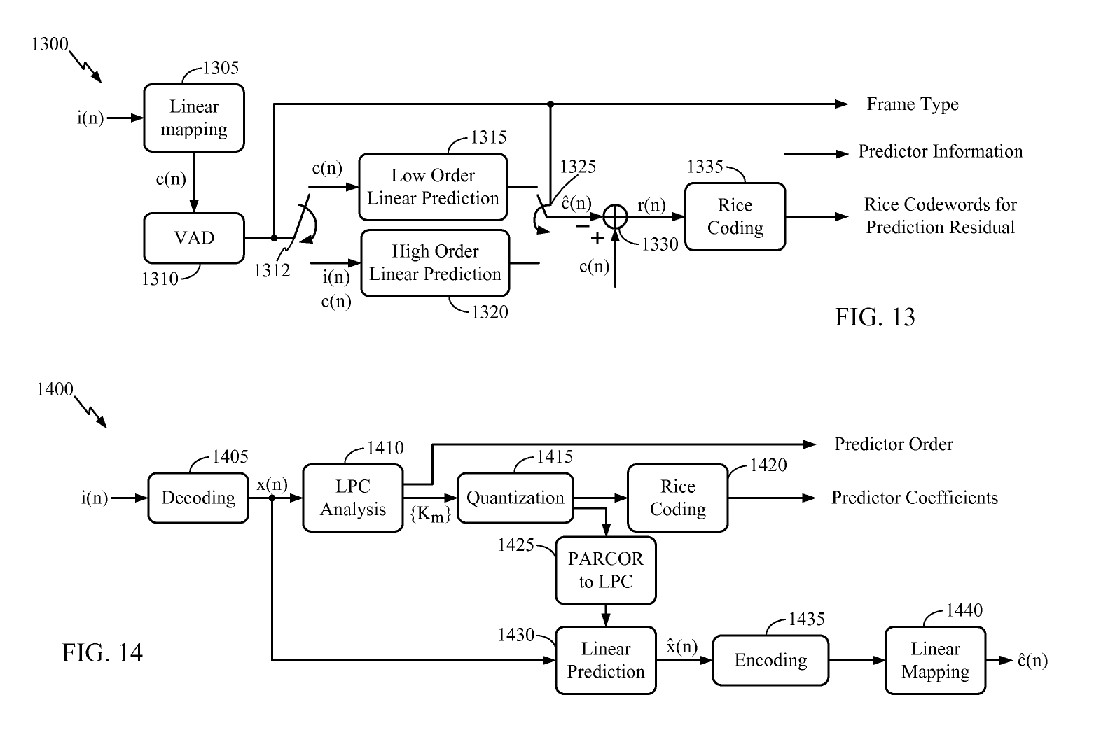

FIG. 14 illustrates a functional block diagram of a system 1400 for performing relatively high order linear prediction according to one or more implementations. For example, system 1400 may be used in place of high order linear prediction block 1320 shown in FIG. 13. Input 8-bit input signal sample values i(n) in a frame may be expanded to a 16-bit PCM sample signal values x(n) by a decoding block 1405. For example, input signal sample values i(n) may be decoded by a G.711 decoder in one or more implementations. With x(n) time-domain signal sample values, a linear prediction coding analysis may be performed by LPC analysis block 1410 to determine a predictor in terms of its order and coefficients. The LPC analysis block 1410 may determine a predictor order and coefficients via an implementation of a Levinson-Durbin process that recursively computes reflection coefficients and a variance of a prediction residual at a prediction order. Derived predictor coefficients, denoted as {kₘ}, may be quantized by quantization block 1415. Quantized predictor coefficients may be encoded and transmitted. In one or more implementations, quantized predictor coefficients may be Rice coded by Rice coding block 1420 and then sent via bitstream packing together with a predictor order.

Quantized predictor coefficients may be provided to PARCOR to LPC block 1425 to determine linear prediction coefficients. A linear prediction block 1430 may utilize linear prediction coefficients and x(n) time-domain signal sample values to estimate or predict signal sample values \hat{x}(n). Using linear prediction coefficients, predicted signal sample values \hat{x}ₘ(n) may be computed and converted to a compressed domain. Predicted signal sample values \hat{x}ₘ(n) may be encoded at encoding block 1435. For example, encoding block 1435 may encode predicted signal sample values \hat{x}ₘ(n) in accordance with G.711. Linear mapping block 1440 may map encoded predicted signal sample values \hat{x}ₘ(n) to generate predicted compressed domain signal sample values ĉ(n) which may be provided to a summer, such as summer 1330 shown in FIG. 13 to determine residual signal sample values. Predicted signal sample values \hat{x}(n) may be mapped to reduce a bitrate of irregular discontinuity on μ- or A-law encoded 8-bit signal sample values. From these linearly-mapped 8-bit signal sample values, a prediction residual is obtained in the 8-bit compressed domain and forwarded for Rice coding.

Referring to FIG. 13, forward adaptive linear prediction and linear prediction coefficient analysis may be performed in low order linear prediction block 1315 using linearly-mapped 8-bit input signal sample values in a silence interval of commanded domain signal sample values c(n). For example, 8-bit signal sample values may be applied to a linear prediction coefficients analysis without conversion to 16-bit PCM sample signal values as in high order linear prediction block 1320, as discussed above with respect to FIG. 14. In a linear prediction coefficient analysis, a search may be employed to output a low number of bits, attempting to compress a given frame for predictor candidates, examining coding results, and selecting as a best predictor one that renders a smaller number of output bits. Once a predictor has been selected in a linear prediction coefficients analysis by low order linear prediction block 1315, information may be coded in a way similar to that discussed above with respect to high order linear prediction shown in FIG. 14. A difference between low order linear prediction block 1315 and high order linear prediction block 1320 is that linear prediction performed in high order linear prediction block 1320 may be performed to compute predicted signal sample values from quantized predictor coefficients and may be directly forwarded to a residual computation performed by summer 1330 without domain conversion by an encoder and an linear mapping discussed with respect to FIG. 14.

A frame classifier may be used to switch between two prediction modes. In an example shown in FIG. 13, a frame classifier may be implemented by a VAD block 1310, which may analyze companded input signal sample values c(n) by measuring and comparing zero-crossing rate and signal energy. After computing by low order linear prediction block 1315 or high order linear prediction block 1320, predictive coding may be performed in a compressed domain, by utilizing summer 1330 to subtract predicted compressed domain signal sample values ĉ(n) from linearly-mapped compressed domain input signal sample values c(n) to determine residual signal sample values r(n). Residual signal sample values r(n) may be Rice coded by Rice coding block 1335.

In an example where a length of input data in not sufficiently long to compute accurate statistics to determine a predictor order, it may be desirable to substitute theoretical estimates of the total bits with the number of bits produced by Rice-coding of computed reflection coefficients and the residual. This approach, however, may involve intensive computations for the following reasons: at a predictor order, (a) FIR filtering may be performed with newly computed predictor coefficients and (b) an actual bit may be computed by considering processes of G.711 encoding, linear mapping and Rice coding of a differentiated predictor residual.

For a computationally less computationally expensive alternative of a search, a lattice predictor may be employed to perform linear prediction coefficients analysis for a prediction order adaptation. A lattice predictor may be efficient in generating a prediction residual, thereby reducing computations which may be employed by FIR filtering to compute predicted signal sample values. Also, a linear prediction coefficients analysis based at least in part on a lattice predictor may be designed to operate with signal sample values in a companded or compressed domain, which may lift a computational burden in bit computation by reducing domain conversion (from time to compressed domain) of a predictor residual. Another computational saving may be made from observations of LPC analysis for frames in a silence interval that (a) high order linear prediction is not effective in bit-rate reduction due at least in part to overhead for predictor coefficients and (b) a low order linear predictor (e.g., Pmax≦6) or a fixed predictor may render a smaller number of bits in some cases. Hence, by applying a linear prediction coefficients analysis to frames in a silence interval and by limiting a possible predictor order (or number of iteration for exhaustive search) to a relatively small Pmax, computation by a lattice linear prediction coefficients analysis with a search may be reduced without significant compromise of coding efficiency.

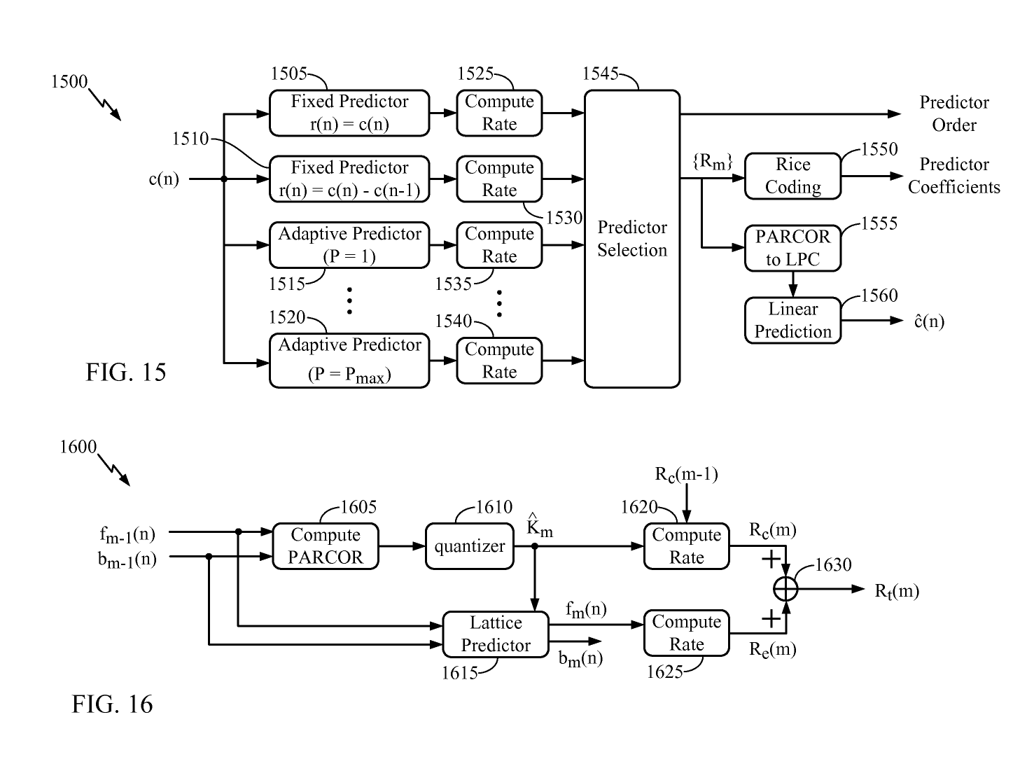

FIG. 15 illustrates a functional block diagram of a system 1500 for performing relatively low order linear prediction according to one or more implementations. A system may be utilized in place of low order linear prediction block 1315 shown in FIG. 13. Input compressed domain signal sample values c(n) may be provided to a first fixed predictor 1505, a second fixed predictor 1510, a first adaptive predictor 1515, and may also be provided, in some implementations, to additional adaptive predictors up through a high value adaptive predictor 1520.

Corresponding bit rates may be determined in compute rate blocks 1525, 1530, 1535, and 1540 for first fixed predictor 1505, second fixed predictor 1510, first adaptive predictor 1515, and max value adaptive predictor 1520, respectively. Bit rates may be provided to a predictor selection block 1545 which may select a predictor order and coefficients base at least in part on a comparison of bit rate changes from compute rate blocks. Selected predictor coefficients are denoted as {kₘ} in FIG. 15 and are provided to an encoder block, such as Rice coding block 1550, and PARCOR to LPC block 1555. Rice coding block 1550 may determine predictor coefficients. PARCOR to LPC block 1555 may convert partial correlation coefficients to linear prediction coefficients and may provide linear prediction coefficients to a linear prediction block 1560. Linear prediction block 1560 may determine predicted compressed domain signal sample values ĉ(n) based at least in part on linear prediction coefficients.

FIG. 16 illustrates a functional block diagram of a process 1600 for computing bit rates for determining linear prediction coefficients according to one or more implementations. For a predictor order m=1, 2, . . . , Pmax, a reflection coefficient utilized by an adaptive predictor may be computed by a compute PARCOR block 1605 based at least in part on forward and backward prediction signal errors, denoted by fₘ(n) and bₘ(n) respectively, as

$${κ}_{m} = \frac{2 {C}_{m - 1}}{{F}_{m - 1} + {B}_{m - 1}} , \\ where$$

$${F}_{m - 1} = {\sum }_{n = 0}^{N - 1} {f}_{m - 1}^{2} ( n ) , \\ {B}_{m - 1} = {\sum }_{n = 0}^{N - 1} {b}_{m - 1}^{2} ( n - 1 ) , \\ {C}_{m - 1} = {\sum }_{n = 0}^{N - 1} {f}_{m - 1} ( n ) {b}_{m - 1} ( n - 1 ) .$$

A computed reflection coefficient may be quantized by quantizer 1610 to generate quantized reflection coefficient \hat{K}ₘ. Quantized reflection coefficient \hat{K}ₘ may be provided to a lattice predictor 1615. Lattice predictor 1615 may determine forward and backward prediction signal errors, denoted by fₘ(n) and bₘ(n). Quantized reflection coefficient \hat{K}ₘ may be provided to first compute rate block 1620 to measure a number of bits for coding a reflection coefficient by taking into account quantization and coding procedures. By adding a calculated number of bits with bits computed in a previous stage, a number of bits Rc(m) for coding coefficients of an m-th predictor may be determined.

A quantized reflection coefficient may be forwarded to a linear prediction of order m, which may be more efficiently performed by taking advantage of a lattice predictor structure. Forward and backward prediction signal errors by an m-th order predictor may be recursively computed in an m-th stage of the lattice predictor as

fₘ(n)=fₘ₋₁(n)−\hat{K}ₘbₘ₋₁(n−1),

bₘ(n)=bₘ₋₁(n−1)−\hat{K}ₘfₘ₋₁(n).

A forward prediction residual fₘ(n) may be provided to a second compute rate block 1625 to determine a number of bits Rₑ(m) for coding, such as Rice coding, of a prediction residual. A Rice parameter k may be determined by applying a procedure discussed above to a given residual fₘ(n). A residual fₘ(n) may be interleaved to a non-negative version r+(n). With derived k and interleaved signal sample values, a number of bits for Rice-coding of a residual may be computed as

$${R}_{e} ( m ) = {\sum }_{n = 0}^{N - 1} ⌊ \frac{{r}^{+} ( n )}{{2}^{k}} ⌋ + ( k + 1 ) N + k + 1 ,$$

A computed number of bits Rₑ(m) for residual coding, together with a number of bits R_{c}(m) for coefficient coding, may be added via summer 1630 to determine a total number of bits Rₜ(m). Total number of bits Rₜ(m) may be forwarded to an order selection block, total number of bits Rₜ(m) may be compared with a number of bits at a previous stage. By iterating procedures at an order from m=1 to Pₘₐₓ, a predictor order and its reflection coefficients may be determined as discussed above with respect to FIG. 15.

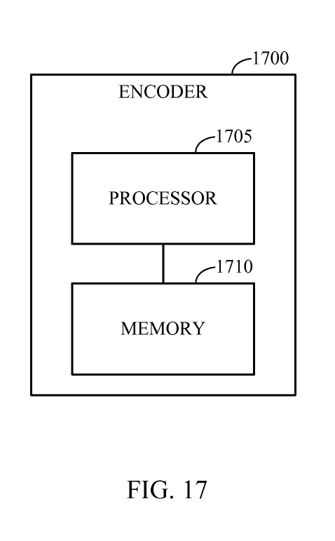

FIG. 17 illustrates an encoder 1700 according to one or more implementations. As shown, encoder 1700 may include at least a processor 1705 and a memory 1710. Processor 1705 may execute code stored on memory 1710 in an example. Encoder 1700 may also include additional elements, such as those discussed above in FIG. 4, for example.

Methodologies described herein may be implemented by various apparatuses depending at least in part upon applications according to particular features or examples. For example, methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform functions described herein, or combinations thereof.

For firmware, hardware, software implementations, certain methodologies may be implemented with modules (e.g., procedures, functions, and so on) that perform functions described herein. Any machine readable medium tangibly embodying instructions may be used in implementing methodologies described herein. For example, software codes may be stored in a memory of a mobile station or an access point and executed by a processing unit of a device. Memory may be implemented within a processing unit or external to a processing unit. As used herein the term “memory” refers to any type of long term, short term, volatile, nonvolatile, or other memory and is not to be limited to any particular type of memory or number of memories, or type of media upon which memory is stored.

If implemented in hardware or software, functions that implement methodologies or portions thereof may be stored on or transmitted over as one or more instructions or code on a computer-readable medium. A computer-readable medium may take the form of an article of manufacture. A computer-readable medium may include computer storage media or communication media including any medium that facilitates transfer of a computer program from one place to another. A storage media may be any available media that may be accessed by a computer or like device. By way of example but not limitation, a computer-readable medium may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

“Instructions” as referred to herein relate to expressions which represent one or more logical operations. For example, instructions may be “machine-readable” by being interpretable by a machine for executing one or more operations on one or more signal data objects. However, this is merely an example of instructions and claimed subject matter is not limited in this respect. In another example, instructions as referred to herein may relate to encoded commands which are executable by a processing unit having a command set which includes the encoded commands. Such an instruction may be encoded in the form of a machine language understood by a processing unit. Again, these are merely examples of an instruction and claimed subject matter is not limited in this respect.

While there has been illustrated and described what are presently considered to be example features, it will be understood by those skilled in the art that various other modifications may be made, or equivalents may be substituted, without departing from claimed subject matter. Additionally, many modifications may be made to adapt a particular situation to teachings of claimed subject matter without departing from central concept(s) described herein. Therefore, it is intended that claimed subject matter not be limited to particular examples disclosed, but that claimed subject matter may also include all aspects falling within the scope of appended claims, or equivalents thereof.

What is claimed is:

1. An apparatus, comprising:
a linear predictor to generate one or more residual signal sample values corresponding to input signal sample values based at least in part on linear predication coding using linear prediction coefficients; and
one or more companders to generate companded domain signal sample values based at least in part on said input signal sample values;
wherein said linear predictor and said one or more companders are arranged in a configuration to generate companded domain residual signal sample values.

2. The apparatus of claim 1 and further comprising:
an encoder to encode said companded domain residual signal sample values.

3. The apparatus of claim 2, wherein said encoder is capable of encoding said companded domain residual signal sample values based at least in part on an estimate of a variance of said companded domain residual signal sample values.

4. The apparatus of claim 1, and further comprising an encoder to encode said linear prediction coefficients.

5. The apparatus of claim 1, wherein said configuration includes a G.711 encoder.

6. The apparatus of claim 1, wherein said linear predictor comprises a lattice predictor structure.

7. The apparatus of claim 3, wherein said encoder is capable of Rice coding said companded residual signal sample values.

8. The apparatus of claim 3, wherein said encoder is capable of determining an absolute moment of sample-based estimates of probabilities of said companded domain residual signal sample values.

9. The apparatus of claim 8, wherein said encoder is capable of determining a variance of distribution of said sample-based estimates of probabilities of said companded domain residual signal sample values based at least in part on said absolute moment.

10. The apparatus of claim 9, wherein said encoder is capable of selecting an encoding scheme for encoding said residual signal sample values based at least in part on said variance of distribution.

11. The apparatus of claim 10, wherein said encoding scheme comprises a Huffman code.

12. The apparatus of claim 10, wherein said encoder is capable of determining a number of bits to represent said encoding scheme based at least in part on an index value corresponding to said variance of distribution.

13. A method, comprising:
generating one or more residual signal sample values corresponding to input signal sample values based at least in part on linear predication coding using linear prediction coefficients;
generating companded domain signal sample values based at least in part on said input signal sample values; and
generating companded domain residual signal sample values based at least in part on said companded domain signal sample values and said mapped signal sample values.

14. The method of claim 13, further comprising encoding said companded domain residual signal sample values.

15. The method of claim 14, further comprising encoding said companded domain residual signal sample values based at least in part on an estimate of a variance of said companded domain residual signal sample values.

16. The method of claim 13, further comprising encoding said linear prediction coefficients.

17. The method of claim 16, wherein said linear prediction coefficients are encoded in accordance with G.711.

18. The method of claim 13, further comprising Rice coding said companded residual signal sample values.

19. The method of claim 13, further comprising determining an absolute moment of sample-based estimates of probabilities of said companded domain residual signal sample values.

20. The method of claim 19, further comprising determining a variance of distribution of said sample-based estimates of probabilities of said companded domain residual signal sample values based at least in part on said absolute moment.

21. The method of claim 20, further comprising selecting an encoding scheme for encoding said residual signal sample values based at least in part on said variance of distribution.

22. The method of claim 21, wherein said encoding scheme comprises a Huffman code.

23. The method of claim 21, further comprising determining a number of bits to represent said encoding scheme based at least in part on an index value corresponding to said variance of distribution.

24. An apparatus, comprising:
means for generating one or more residual signal sample values corresponding to input signal sample values based at least in part on linear predication coding using linear prediction coefficients;
means for generating companded domain signal sample values based at least in part on said input signal sample values; and
means for generating companded domain residual signal sample values based at least in part on said companded domain signal sample values and said mapped signal sample values.

25. The apparatus of claim 24, further comprising means for encoding said companded domain residual signal sample values.

26. The apparatus of claim 25, further comprising means for encoding said companded domain residual signal sample values based at least in part on an estimate of a variance of said companded domain residual signal sample values.

27. The apparatus of claim 24, further comprising means for encoding said linear prediction coefficients.

28. The apparatus of claim 27, wherein said means for encoding is capable of encoding said linear prediction coefficients in accordance with G.711.

29. The apparatus of claim 24, further comprising means for Rice coding said companded residual signal sample values.

30. The apparatus of claim 24, further comprising means for determining an absolute moment of sample-based estimates of probabilities of said companded domain residual signal sample values.

31. The apparatus of claim 30, further comprising means for determining a variance of distribution of said sample-based estimates of probabilities of said companded domain residual signal sample values based at least in part on said absolute moment.

32. The apparatus of claim 31, further comprising means for selecting an encoding scheme for encoding said residual signal sample values based at least in part on said variance of distribution.

33. The apparatus of claim 32, wherein said encoding scheme comprises a Huffman code.

34. The apparatus of claim 32, further comprising means for determining a number of bits to represent said encoding scheme based at least in part on an index value corresponding to said variance of distribution.

35. An article comprising: a storage medium having stored thereon instructions executable by a processor to:
generate one or more residual signal sample values corresponding to input signal sample values based at least in part on linear predication coding using linear prediction coefficients;
generate companded domain signal sample values based at least in part on said input signal sample values; and
generate companded domain residual signal sample values based at least in part on said companded domain signal sample values and said mapped signal sample values.

36. The article of claim 35, wherein said instructions are further executable by said processor to encode said companded domain residual signal sample values.

37. The article of claim 36, wherein said instructions are further executable by said processor to encode said companded domain residual signal sample values based at least in part on an estimate of a variance of said companded domain residual signal sample values.

38. The article of claim 35, wherein said instructions are further executable by said processor to encode said linear prediction coefficients.

39. The article of claim 38, wherein said instructions are further executable by said processor to encode said linear prediction coefficients in accordance with G.711.

40. The article of claim 35, wherein said instructions are further executable by said processor to Rice code said companded residual signal sample values.

41. The article of claim 35, wherein said instructions are further executable by said processor to determine an absolute moment of sample-based estimates of probabilities of said companded domain residual signal sample values.

42. The article of claim 41, wherein said instructions are further executable by said processor to determine a variance of distribution of said sample-based estimates of probabilities of said companded domain residual signal sample values based at least in part on said absolute moment.

43. The article of claim 42, wherein said instructions are further executable by said processor to select an encoding scheme for encoding said residual signal sample values based at least in part on said variance of distribution.

44. The article of claim 43, wherein said encoding scheme comprises a Huffman code.

45. The article of claim 43, wherein said instructions are further executable by said processor to determine a number of bits to represent said encoding scheme based at least in part on an index value corresponding to said variance of distribution.
